(19) United States
(12) Patent Application Publication
(10) Pub. No.: US 2010/0122003 A1
(43) Pub. Date: May 13, 2010

(54) RING-BASED HIGH SPEED BUS INTERFACE

(75) Inventors: Junquiang Hu, Davis, CA (US); Ting Wang, West Windsor, NJ (US); Philip N. Ji, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/549,515

(22) Filed: Aug. 28, 2009

Related U.S. Application Data
(60) Provisional application No. 61/112,938, filed on Nov. 10, 2008.

(51) Int. Cl. G06F 13/00

(52) U.S. Cl. 710/110

(57) ABSTRACT

A communication system management interface includes a control master; and one or more slaves under management by the control master; wherein each device, either the control master or slave, has at least an input signal connected to an output signal of another device to form a daisy-chain.

The present invention relates to a ring-based bus interface.

### BACKGROUND

The emergence of smart appliances and consumer electronics has been driven by powerful, yet low cost processors such as 16-bit or 32-bit micro-controllers. A micro-controller circuit typically uses a micro-controller interface for configuration, control, and monitoring the micro-controller. These micro-controllers access memory and a variety of peripherals needed to support sophisticated features in the appliances and electronics. For systems with multiple blades and interconnected through backplane, this controller interface requires connection from one blade (or external equipment) to all others, which can be a large number and greatly increase the design complexity. As micro-controllers have become more powerful, the I/O throughput becomes the bottleneck, especially for digital-signal-processing (DSP) systems with large data input. The current commonly used solutions of the micro-controller interface include bus-type parallel interface, I2C serial bus interface, cascaded serial interface, and point-to-point interface through a central switching device, among others.

FIG. 1 shows an exemplary bus-type parallel connection. The system of FIG. 1 is the most popular micro-controller interface scheme that is widely used within the systems. The micro-controller has multiple bits for address output, data input/output, and one or more bits for control signal (for example, read/write and chip enable). The address output can also be combined with the data input/output in some implementations. A clock signal can be generated outside of these devices (including the micro-controller and the devices under control).

Referring now to FIG. 1, within system 100, micro-controller 102 has control over device 1 to n (104). The signals include unidirectional control 106 (for example, chip enable and read/write), unidirectional address 108, bidirectional data 112, and one clock signal 110. Control 106 and address 108 are output from micro-controller 102 to each device 104; data 112 can be either from micro-controller to the devices 104, or the reverse direction; clock 110 is generated within the system and connected to both the micro-controller 102 and the devices 104. A pre-defined segment address is used to access a given device. This bus-type connection usually has less than 100 MHz performance.

FIG. 2 shows an exemplary bus-type serial interface. A typical example of this solution is Inter-Integrated Circuit I²C protocol, which is a multi-master serial bus to attach low-speed peripherals to a motherboard, embedded system, or cell phone. I²C uses only two bidirectional signals, Serial Data (SDA) and Serial Clock (SCL), to enable the communication. The bus has two roles for each node: master and slave:

Master node—node that issues the clock and addresses slaves

Slave node—node that receives the clock line and address.

The bus is a multi-master bus which means any number of master nodes can be present. Additionally, master and slave roles may be changed between messages. FIG. 2 illustrates the I2C serial bus with multiple masters 202 and multiple slaves 204, together with the inter-connection signals SDA 206 and SCL 208. The most common I²C bus modes are the 100 kbit/s standard mode and the 10 kbit/s low-speed mode. Recent revisions of I²C can host more nodes and run faster (400 kbit/s Fast mode, 1 Mbit/s Fast mode plus or Fm+, and 3.4 Mbit/s High Speed mode).

FIG. 3 shows a cascaded serial link connection. The Joint Test Action Group (JTAG) interface is the typical example of cascaded serial interface, though its original purpose was providing a “Standard Test Access Port and Boundary-Scan Architecture” for testing printed circuit boards using boundary scan, as defined in IEEE 1149.1. Besides the function of accessing sub-blocks of integrated circuits, it is also used for debugging embedded systems, or programming/configuring the devices. The JTAG interface is a five-pin interface, with signals including:

a. TDI: Test Data Input

b. TDO: Test Data Output

c. TCK: Test Clock

d. TMS: Test Mode Select

e. TRST: Test Reset (optional)

Among these signals, TCK, TMS, and TRST are common signals generated from the master/controller; TDI and TDO are serial data interfaces to/from the devices under debugging/programming/configuring. The devices are daisy-chained together through the TDI and TDO signals. FIG. 3 illustrates the typical JTAG chain 300, where the master device 301 corresponds to the micro-controller, and devices 304 are the devices to be debugged/conFIG.d/managed. Tclk 314, Trst 310, and TMS 312 are common signals output from master device 302; signals TDI 306 and TDO 308 connect both the master controller and the slave devices in a daisy-chain. The operating frequency of TCK varies depending on the chip, but is typically 10 to 100 MHz.

FIG. 4 shows an exemplary connection through a central switching device. Besides the controller and the devices under management, an additional central switching point is needed in this solution. As illustrated in FIG. 4, system 400 has both the controller 402 and the devices 406 under management connected to a central switching device 404. The connections 408 between controller 402 and the switching hub 404, or device 406 and switching hub 404, are usually dual directional, either by one or more dual directional signal, or by different signals. A pre-known or registered address or device ID is used to access a specific device. One typical example of this connection is Ethernet; another example is Universal Serial Bus (USB). The operating speed varies from Mega bit per second to Giga bit per second. The additional switching device increases the system cost and design complexity.

Besides the above types of interfaces for multiple devices management, for the communication to a single device or equipment, a simple point-to-point interface also exists. One common example is RS232; another example is non-standard company/device specific interfaces like Analog Devices SDA interface.

### SUMMARY

In one aspect, a communication system management interface includes a control master; and one or more slaves under management by the control master; wherein each device, either the control master or slave, has at least an input signal connected to an output signal of another device to form a daisy-chain.

In another aspect, a protocol enables the communication between a master controller and one or more slave devices, wherein the master controller and slave devices form a ring, and the communication is initialized by the master. The protocol includes a pre-defined START sequence to identify the start of a frame; a length field to identify or enable the calculation of the frame length; a device ID field to notify the addressee device; an operation mode field for the operation of read, write, query, or others; an address field for the address in a target device; and a data field for write operation.

In yet another aspect, a method enables efficient communication between a master controller and one or more slave devices, wherein the master controller and slaves form a ring, and wherein the master controller initiates communication. The method includes updating data in a frame by: using a pre-defined START sequence to identify the start of a frame; using a length field to identify or enable frame length determination; updating a device ID field to notify the addressee device; updating an operation mode field for the operation of read, write, query, or other operation; updating an address field for the address in the target device; and updating a data field for write operation. Upon receiving a frame, checking the device ID field at a slave device, if the device ID is not equal to the slave device ID, passing the frame to the next slave device. If device ID equals to the slave device ID, for read operation, reading from internal registers and appends the result to the end of the frame, in data field, and transmits the new frame to the next device; and for write operation, writing one or more internal registers using the address and data in the frame and terminating the frame.

In a further aspect, the master/slave devices arranged in a daisy chain, and communicate through high-speed serial links; point-to-point clock and data connection for the management interface to enable high-speed communication; unidirectional data transfer to improve communication efficiency; one-by-one dynamic device ID configuration during initialization.

Advantages of the preferred embodiment(s) may include one or more of the following. The system supports point-to-point high-speed serial signal for communication to improve the data rate and reduce the number of required signals. The architecture of the system organizes the micro-controller and the devices under management in a daisy-chain. The system supports unidirectional signal transmission which avoids complicated timing control. The signal type can be either source synchronized Double-Data-Rate (DDR) which has a clock signal accompanying the data, or data signal only which requires clock/data recovery within the receiver device. The system uses fewer signals for interconnection yet maintains a relatively high throughput. The reduction in signal requirement reduces the system design complexity and device I/O constraints while meeting the performance requirement. The reduced connection complexity and increased data transfer performance are also advantageous. By providing high performance, fewer microcontrollers may be required which leads to reduced cost. Additionally, the reduced number of signals may also reduce the board layers, resulting in additional cost reduction of the end product. The high throughput of the interface allows fast data collection to reduce the debugging time during system development or for other purposes, and enable real-time anomaly detection/reaction during normal operation.

### BRIEF DESCRIPTION OF THE DRAWINGS

FIG. 1 shows an exemplary bus-type parallel connection.

FIG. 2 shows an exemplary bus-type serial interface.

FIG. 3 shows a cascaded serial link connection.

FIG. 4 shows an exemplary connection through a central switching device.

FIG. 5 shows an exemplary management interface architecture in accordance with the present invention.

FIG. 6 shows one example of the frame definition, for command of simple read/write/query operations outputs from the micro-controller.

FIG. 7 is an exemplary flow chart illustrating a response procedure in the slave device upon receiving a command.

FIG. 8 shows one example of a frame format that supports multiple operations or non-continuous address access.

FIG. 9 shows an exemplary transmission timing sequence.

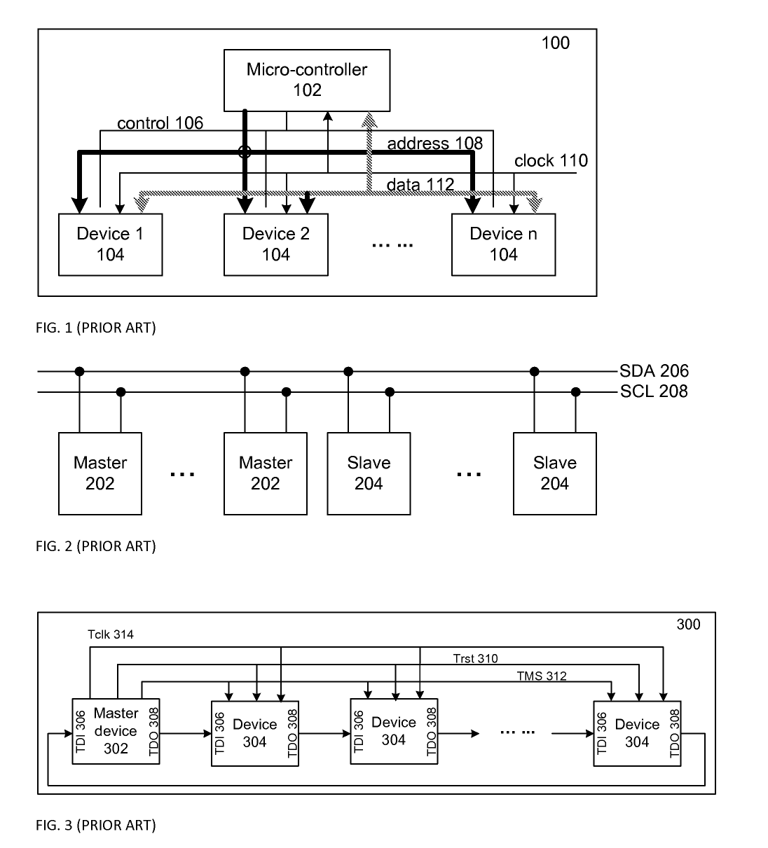

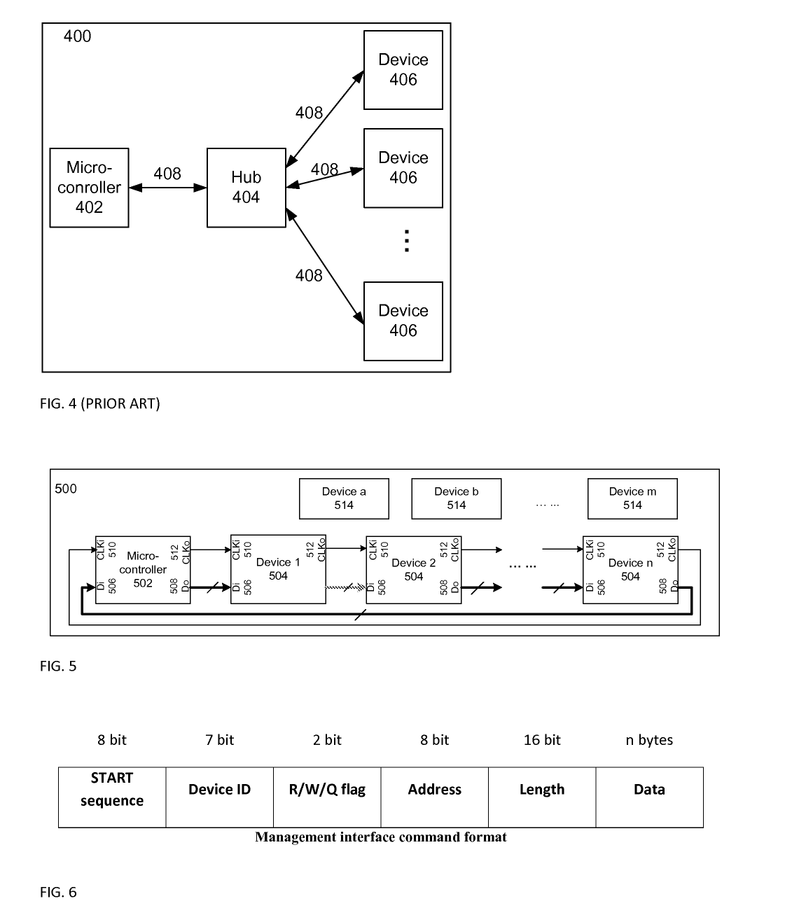

### DESCRIPTION

FIG. 5 shows an exemplary management interface architecture in accordance with the present invention. System 500 contains micro-controller 502 which is the main management unit, devices 504 under management (for example, DSP chip), and devices 514 that do not have management interfaces (for example, configuration flash memory). Micro-controller 502 is the master of the communication chain; it initiates and terminates the communication. Devices 504 are arranged in a cascaded way through point-to-point signals; one only accepts input from the previous device or the master (if it is the first device in the chain, i.e., device 1 in FIG. 5). The output of the last device (i.e., device n in FIG. 5) is connected to the input ports of the master (i.e., the micro-controller 502). This interconnection forms a daisy-chain, where each device 504 and the micro-controller 502 have identical connection. The input signals include one clock (CLKi 510) and one or more data (Di 506); accordingly, the output signals also include one clock (CLKo 512) and one or more data (Do 508). CLKi 510 is connected to CLKo 512, and Di 506 is connected to Do 508 of the previous stage. To increase the communication throughput, differential signals can be used instead of single-ended; the accompanied clock is synchronized to the data (which is called source synchronized). The transmitted data may be either single data rate (SDR) or double data rate (DDR). The signal transmission is unidirectional. A reset signal may be generated from the micro-controller to all the devices in the chain.

The management interface command/response is frame based, and initiated by the micro-controller. FIG. 6 shows one example of the frame definition, for command of simple read/write/query operations outputs from the micro-controller, as one embodiment of the present invention. The “START sequence” is a pre-defined pattern (for example, START sequence=0xCC) to inform the devices of the start of the frame. “Device ID” is the unique ID of each device, which can be predefined for each device, and preset in the micro-controller, or obtained through a certain registering procedure. “R/W/Q flag” is the field for message type, either read, write, or query, where “read” is to get the content of certain address from the target device, “write” is to set the content of certain address in the target, “query” is to ask whether the target has any information to send back to the micro-controller. “Address” field gives the start address in the target device, to access or set the data. “Length” is the number of bytes to read/write, from the start address. For example, if Address=0x0a, Length=0x10, then the operation will include the registers (or memory) from address 0x0a to 0x1a. “Data” field only exists when the command is “write”, where it gives the content to be set to the target address. This frame format is suitable for operations of continuous address.

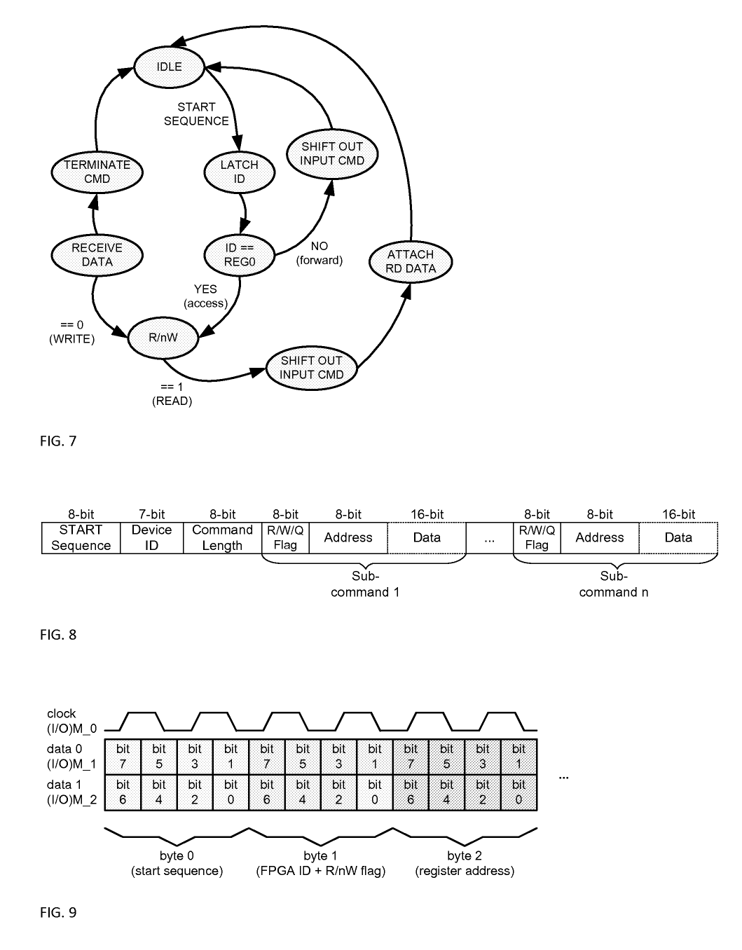

Upon receiving the command, the slave device latches the Device ID and compares with the internal pre-registered ID register value. If they match, the slave device receives the full command. Otherwise, the current device passes the received frame through to the next device in the chain, without modification. If the command is “write”, the data is written to the appropriate register(s) and command is terminated in the addressed device, meaning that no outputs (e.g., the output signals are tied to either 0 or 1) are present to the next device in the chain. For read operation, the addressed device will attach the required amount (i.e., the number given in “Length” field) of data to the end of the command sent from the master, which will be the added “Data” field. For read commands the addressed device is not terminating the command but sending with added “Data field” to its output, as the response frame. The response frame passes through the remaining devices in the chain until it reaches the master device. The read command will be terminated in the master device. If a write command returns to the master device, the addressed device does not present in the chain and the operation is fail. FIG. 7 is the flow chart illustrating the response procedure in the slave device, upon receiving a command, as one embodiment of the present invention.

In one embodiment of the present invention, the device ID can be automatically assigned. The device ID is stored in a particular register within each slave device. After system powered up, all the devices in the communication chain will have the default ID set to, for example, 0xFFFF. The master device first sends command with device ID=0xFFFF, to the address of the device ID register, with data field equals to the assigned device ID to the first device in the chain. Because 0xFFFF matches the initial device ID within the first device in the chain, this first device ID will be set and it will not response to the subsequent device ID setting commands. The next setting command will be accepted by the second device in the chain, and so on, until the master device receives the device ID setting command by itself, which means all the devices in the chain have been assigned.

A broadcast device ID (e.g., 0x7F) may be defined to enable writing access to all the slave devices in the chain. Upon receiving writing command to a broadcast address, the slave device still writes the register(s) according to the command, and shifts the command out to the next device in the chain, instead of terminating it. In another embodiment, the writing command can contain a multicast address where the number of bits in “Device ID” field should be equal to or larger than the maximum number of supported slave devices in the chain. Upon receiving a multicast address, the slave device checks whether the bit for this particular device is valid. If valid, it will set the register(s) given in “Address” field. In the mean time, it erases its own bit in “Device ID” field, checks whether the remaining bits in “Device ID” are zero. If all zero, it will terminate the command; otherwise, the command with modified “Device ID” field will be shifted out to the next device in the chain.

Writing command termination provides a solution to partly detect that the writing operation is success. In case further actions are taken to guarantee the execution correctness (for example, another read followed by write to the same register for data checking), this termination can be performed by the master device to let the slave devices continuously shift out the received frame, to simplify the logic design.

To further increase the operation efficiency and flexibility, in another embodiment, each command can contain different operations for non-continuous addresses. FIG. 8 shows one example of a frame format that supports multiple operations or non-continuous address access. The “START Sequence” and “Device ID” fields are the same as FIG. 6; the “Command Length” field now represents the number of sub-commands within the frame. Within each sub-command, an “R/W/Q Flag” is used to identify the message type, either read, write or query. The “Address” field is the address for single access; the presence of “Data” field depends on the sub-command type. Frame format in FIG. 6 and FIG. 8 can be further combined to form a complicated command to enable efficient and flexible operation.

Next, the command representation by physical signals will be discussed. The above mentioned frame format are transmitted over signals defined in FIG. 5. One embodiment is to transmit the data together with the clock signal, which is source-synchronized, and all the signals within the chain are synchronized to the clock of the master device. Both the clock signal and the data signals(s) can be either single-ended or differential. The clock can be either single data rate (SDR) or double data rate (DDR). Each slave device simply passes the input clock to the output. For data output from a slave device, it is clocked by either the input or output clock, which has the same frequency.

FIG. 9 shows one example of the signal representation by the physical signals, where the signals include one clock and two data. Data 0 and data 1 are synchronous to the source clock; the odd bits of the frame are transmitted through data 0 and even bits are transmitted through data 1, sequentially. In another embodiment, each slave device can use its internal clock to shift out the data, so that the output data is synchronized to its own clock. With this embodiment, an internal buffer is necessary to isolate the different clock domain. In a further embodiment, each device, including both the master and slaves, can have a clock recovery module to re-generate the clock from the received data, in which there is no clock signal transmitted through the chain.

The system may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A communication system management interface, comprising:
a control master; and
one or more slaves under management by the control master;
wherein each device, either the control master or slave, has at least an input signal connected to an output signal of another device to form a daisy-chain and wherein the input signal or output signal comprises a clock signal synchronous with one or more data signals.

2. The management interface of claim 1, wherein the input signal or output signal comprises a clock signal and one or more data signals, wherein the clock signal is source synchronous to the data.

3. The management interface of claim 1, the output signal is generated from the control master and transmitted one by one to each device in the daisy-chain.

4. The management interface of claim 1, wherein each slave device data output is synchronous to an input clock.

5. The management interface of claim 1, wherein the data output from the control master is synchronous to an internally generated output clock.

6. The management interface of claim 1, wherein an output clock is generated within each device and a data output is re-synchronized to the output clock.

7. The management interface of claim 1, comprising a reset signal to reset the one or more slaves.

8. The management interface of claim 7, wherein the reset signal is distributed from the control master to the slaves.

9. The management interface of claim 7, wherein the reset signal is in the daisy-chain.

10. The management interface of claim 1, wherein the input/output signals include one or more data signals only and wherein the input signal comprises a clock recovery circuit to generate the clock signal.

11. The management interface communication of claim 1, wherein communication is initiated by the control master.

12. A protocol to enable communication between a master controller and one or more slave devices, wherein the master controller and slave devices form a ring, and the communication is initialized by the master, the protocol comprising:
a pre-defined START sequence to identify the start of a frame;
a length field to identify or enable a determination of a frame length;
a device ID field to notify an addressee device;
an operation mode field for the operation of read, write, query, or other operation;
an address field for the address in a target device; and
a data field for write operation.

13. The protocol of claim 12, wherein upon receiving a frame, the slave device checks the device identification (ID) field, and if the ID field is not equal to the slave device ID, the slave device passes the frame to a subsequent device.

14. The protocol of claim 12, wherein for read operation, if the device ID field matches the slave device identification, the slave device reads from an internal register and appends the result to the end of the frame, in data field, and transmits the frame to the next device.

15. The protocol of claim 12, wherein for write operation, the slave device writes to an internal register using the address and data in the frame and terminates the frame.

16. The protocol in claim 12, wherein the device ID is dynamically configured during initialization phase.

17. The protocol in claim 12, wherein the device ID is stored in an internal register with the same addresses for devices and known to the master controller, the device ID register within each device is initialized to a pre-defined value, where the value is the same for all devices and known to the master controller, where the master controller transmit a command with Device ID set to the pre-defined value, address set to the device ID register, and data field set to an assigned ID.

18. The protocol in claim 12, wherein upon receiving the frame, a first un-configured device terminates the frame and set its device ID with a value in the frame.

19. The protocol in claim 12, wherein the master controller assigns the device ID to each subsequent device in the chain.

20. The protocol in claim 12, wherein the frame comprises a broadcast command, and wherein each slave device includes:
applying a dedicated broadcast ID for broadcast writing;
upon receiving broadcast frame, writing the slave device register according to the command; and
passing the frame through to the next device.

21. The protocol in claim 12, wherein the frame comprises a multicast command, wherein each device ID bit is used to identify a particular slave device.

22. The protocol of claim 21, wherein a slave device determines if a corresponding bit in ID field is set, and wherein each slave device writes an internal address according to the address and data in the frame, clears a corresponding bit in device ID field, and passes the frame through to the next device in the chain.

23. The protocol of claim 21, wherein if the device ID field is not zero, the slave device terminates the multicast packet at a particular device when all other bits are zero.

24. A method to communicate between a master controller and one or more slave devices, wherein the master controller and slaves form a ring, and wherein the master controller initiates communication, the method comprising:
updating data in a frame by:
using a pre-defined START sequence to identify the start of a frame;
using a length field to identify or enable frame length determination;
updating a device ID field to notify an addressee device;
updating an operation mode field for a read, write, query, or other operation;
updating an address field for an address in a target device; and
updating a data field for write operation;
upon receiving a frame, checking the device ID field at a slave device,
if the device ID is not equal to the slave device ID, passing the frame to the next slave device;
if device ID equals to the slave device ID:
for read operation, reading from internal registers and appends a result to an end of the frame, in data field, and transmits the new frame to the next device;
for write operation, writing one or more internal registers using the address and data in the frame and terminating the frame.

25. The method of claim 24, comprising dynamically updating the device ID during initialization phase.

26. The method of claim 25, comprising:
storing the device ID in internal registers, which has same address for all the devices and known to the master;
initializing the device ID register within each device to a pre-defined value, where this value is the same for all the devices and known to the master controller;
transmitting from the master controller a command with the Device ID set to the pre-defined value, address set to the device ID register, and data field set to an assigned ID;
upon receiving this frame, terminating at the first un-configured device the frame and setting the device ID with the value in this frame; and
assigning the device ID to each subsequent devices in a daisy chain.

27. The method of claim 24, wherein the frame can be a broadcast command.

28. The method of claim 24, comprising using a dedicated broadcast ID for multicast writing.

29. The method of claim 24, wherein upon receiving broadcast frame, the slave device writes the register according to the command, and passes the frame through to the next device.

30. The method of claim 24, where the frame comprises a multicast command.

31. The method of claim 30, wherein each device ID bit is used to identify a particular device.

32. The method of claim 30, wherein for a particular slave device, if a corresponding bit in ID field is 1, comprising writing an internal address according using the address and data in the frame, clearing the corresponding bit in device ID field, and passing the frame through to the next device in the chain.

33. The method of claim 30, wherein for a particular slave device, if the device ID field is not all zero, comprising terminating the multicast packet at a particular device when all other bits are zero.
